(19) United States
(12) Patent Application Publication
(10) Pub. No.: US 2020/0123684 A1
(43) Pub. Date: Apr. 23, 2020

(54) DECORATIVE MATERIAL AND VEHICLE INTERIOR MATERIAL

(71) Applicant: SUMINOE TEXTILE CO., LTD., Osaka (JP)

(72) Inventor: Jiro NISHIMURA, Osaka (JP)

(73) Assignee: SUMINOE TEXTILE CO., LTD., Osaka (JP)

(21) Appl. No.: 16/605,674

(22) PCT Filed: Apr. 18, 2017
(86) PCT No.: PCT/JP2017/015556

§ 371 Date: Oct. 16, 2019

(51) Int. Cl. D03D 3/02; B32B 5/02; B60N 2/58; D03D 1/00; D03D 15/00

(52) U.S. Cl. CPC D03D 3/02; B32B 5/024; B60N 2/5883; D10B 2505/08; D03D 15/0011; D10B 2401/04; D03D 1/00

(57) ABSTRACT

A high-quality decorative material in which a linear light guide body or a linear light emitting body is less likely to be damaged and less likely to cause a losing shape in a woven fabric portion. The decorative material is provided with a beading portion including a bag structure portion composed of a tubular fabric and one or a plurality of linear bodies arranged inside the bag structure portion. The linear body is composed of a linear light guide body or a linear light emitting body. A warp yarn constituting the bag structure portion is configured to include at least a thermally fusible yarn. The warp yarn is composed of a twisted yarn in which a thermally fusible yarn and a non-thermally fusible yarn are twisted together.

### TECHNICAL FIELD

The present invention relates to a decorative material preferably used as a vehicle interior material, such as, e.g., an interior material for an automobile instrument panel, an interior material for an automobile door, and an interior material for an automobile ceiling material, and also preferably used as a decorative material for indoor use for an indoor interior material, a carpet, a stand light, bedding, and the like.

Note that in the claims and the specification of this application, the term “linear” in a linear body, a linear light guide body, a linear light emitting body, and the like, is used to include the meaning of a tubular shape. That is, the term “linear body” is used to include the meaning of a tubular body, the term “linear light guide body” is used to include the meaning of a tubular light guide, and the term. “linear light emitting body” is used to include the meaning of a tubular light emitting body.

Furthermore note that in the claims and the specification of this application, the term “L value” refers to an L value measured according to JIS Z8722-2009.

### BACKGROUND ART

In recent years, a light decoration in which a part of a fabric using an optical fiber is illuminated to show, for example, a light emission pattern, etc., has been proposed. For example, in Patent Document 1, an optical fiber fabric is proposed in which a plurality of warp yarns composed of optical fibers and a plurality of warp yarns composed of ordinary yarns are alternately arranged, and weft yarns arranged on the front and back of the optical fibers and warp yarns composed of ordinary yarns, or connected warp yarns arranged at predetermined intervals are interlaced and integrated, and in which, depending on how the surfaces of the optical fibers are covered with warp yarns composed of ordinary yarns and weft yarns, a pattern is shown on the fabric surface in an area in which the degree of exposure of the optical fiber is low and an area in which the degree of exposure thereof is high.

By adopting such a configuration, a part of the fabric can be illuminated by the light from the optical fiber, so that the interesting feature and design can be enhanced. Further, it is also possible to optically display character information by the expressed pattern (see FIG. 10 of Patent Document 1).

### PRIOR ART DOCUMENT

### Patent Document

Patent Document 1: Japanese Unexamined Patent Application Publication No. 2016-37688

### SUMMARY OF THE INVENTION

### Problems to be Solved by the Invention

However, in the aforementioned prior art, since the optical fibers are exposed on the surface of the optical fiber fabric, when the optical fiber fabric is used for an application where a person sits, such as a skin material for a vehicle seat sheet, etc., there is a problem that the optical fiber is easily damaged. Further, there is a possibility that the optical fiber is damaged in cases where the optical fiber fabric is used in applications, such as, e.g., a vehicle interior material, in which a user's hand touches.

Furthermore, in the aforementioned prior art, it is manufactured through a weaving process in which a plurality of warp yarns composed of optical fibers and a plurality of warp yarns composed of ordinary yarns are alternately arranged. Therefore, the difficulty of weaving in this weaving process is considerably high, so there was a problem that the weaving property in the weaving process (weaving property that can be woven by precisely aligning warp yarns) was not so great. When the weaving property is poor as described above, the product quality decreases. Furthermore, there was a problem that a fabric composed of a plurality of optical fiber warp yarns is likely to cause “losing shape”.

The present invention has been made in view of the aforementioned technical background, and aims to provide a high quality decorative material in which, for example, even when used in applications in which a person sits thereon or a hand touches, a linear light guide body or a linear light emitting body, such as, e.g., an optical fiber, is less likely to cause damage and a woven fabric portion is less likely to cause losing shape.

### Means for Solving the Problems

In order to attain the aforementioned object, the present invention provides the following means.

[1] A decorative material comprising:

a beading portion including a bag structure composed of a tubular fabric and one or a plurality of linear bodies arranged inside the bag structure portion,

wherein the linear body includes one of a linear light guide body and a linear light emitting body, and

wherein a warp yarn constituting the bag structure portion is configured to include at least a thermally fusible yarn.

[2] The decorative material as recited in the aforementioned Item [1],

wherein the warp yarn is composed of a twisted yarn in which thermally fusible yarn and a non-thermally fusible yarn are twisted together.

[3] A decorative material comprising:

a beading portion including a bag structure portion composed of a tubular fabric and one or a plurality of linear bodies arranged inside the bag structure portion,

wherein the linear body include one of a linear light guide body and a linear light emitting body, and

wherein a weft yarn constituting the bag structure portion is configured co include at least a thermally fusible yarn.

[4] The decorative material as recited in the aforementioned Item [3],

wherein the weft yarn is composed of a twisted yarn in which a thermally fusible yarn and a non-thermally fusible yarn are twisted together.

[5] The decorative material as recited in any one of the aforementioned Items to [4],

wherein one of the warp yarn and weft yarn constituting the bag structure portion includes a yarn having an L value in a range of 0 to 50, and the other of the warp yarn and the weft yarn includes a yarn having an L value in a range of 70 to 100.

[6] The decorative material as recited any one of the aforementioned Items [1] to [5], further comprising:

a substantially rectangular seam allowance portion connected to one end portion side of the bag structure portion in a width direction.

[7] The decorative material as recited in any one of the aforementioned Items [1] to [5], further comprising:

a substantially rectangular first seam allowance portion connected to one end portion side of the bag structure portion in a width direction; and

a substantially rectangular second seam allowance portion connected to the other end portion side of the beading portion in the width direction.

[8] The decorative material as recited in any one of the aforementioned Items [1] to [7],

wherein the linear body has a diameter of 3.0 mm to 7.0 mm.

[9] The decorative material as recited in any one of the aforementioned Items [1] to [8],

wherein the linear body is composed of an optical fiber.

[10] A vehicle interior material comprising:

a first fabric;

a second fabric; and

the decorative material as recited. in the aforementioned Item [6],

wherein the seam allowance portion of the decorative material is sandwiched between an end portion of the first fabric and an end portion of the second fabric, and the seam allowance portion, the end portion of the first fabric, and the end portion of the second fabric are sewed together in a state of being overlapped.

[11] A vehicle interior material comprising:

a first fabric;

a second fabric; and

the decorative material as recited in Item [7],

wherein an end portion of the first fabric is overlapped with the first seam allowance portion of the decorative material, and the end portion of the first fabric and the first seam allowance portion are sewed together, and

wherein an end portion of the second fabric is overlapped with the second seam allowance portion of the decorative material, and the end portion of the second fabric and the second seam allowance portion are sewed together.

### EFFECTS OF THE INVENTION

In the invention as recited in the aforementioned Items [1] and [3], it is configured such that a linear body (a linear light guide body such as an optical fiber or a linear light emitting body such as an EL fiber) is inserted and arranged inside a bag structure portion composed of a tubular fabric. Therefore, the linear light guide body such as an optical fiber or the linear light emitting body such as an EL fiber is less likely to be damaged even when used in applications in which, for example, a person sits thereon or hands touch. Further, in the invention as recited in the aforementioned Item [1], the warp yarn constituting the bag structure portion is configured to include at least a thermally fusible yarn, and the thermally fusible yarn is fused to a weft yarn. Furthermore, in the invention as recited in the aforementioned Item [3] , the weft yarn constituting the bag structure portion is configured to include at least a thermally fusible yarn and the thermally fusible yarn is fused to the warp yarn. Therefore, the bag structure portion is less likely to cause losing shape, and the bag structure portion is less likely to wear out and has excellent wear durability, so that a high quality decorative material can be provided. In addition, since a linear body such as an optical fiber is not woven into a fabric using a warp yarn as in the prior art, but it is configured such that a linear body (a linear light guide body such as an optical fiber or a linear light emitting body such as an EL fiber and the like) is arranged inside the bag structure portion composed of a tubular fabric, and therefore weaving ls easy. Also, a new and unique light decoration technique can be provided in which light from a linear body (a linear light guide body such as an optical fiber or a linear light emitting body such as an EL fiber) leaks through the bag structure portion to the outside.

In the invention as recited in the aforementioned Item [2] , since the warp yarn is composed of a twisted yarn (a twisted yarn composed of a thermally fusible yarn and a non-thermally fusible yarn) in which a thermally fusible yarn and a non-thermally fusible yarn are twisted together, the bag structure portion is even more unlikely to cause losing shape, which can further improve the abrasion durability of the bag structure portion.

In the invention as recited in the aforementioned Item [4], since the weft yarn is composed of a twisted yarn (a twisted yarn composed of a thermally fusible yarn and a non-thermally fusible yarn) in which a thermally fusible yarn and a non-thermally fusible yarn are twisted, the bag structure portion is even more unlikely to cause losing shape, so that the abrasion durability of the bag structure portion can be further improved.

In the invention as recited in the aforementioned Item [5], it is configured such that for one of the weft yarn. and the warp yarn, at least a yarn having an L value in a range of 0 to 50 is used, and for the other of the weft yarn and the warp yarn, at least a yarn having an L value in a range to 70 to 100 is used. Therefore, the light of the linear body (the linear light guide body or the linear light emitting body) is sufficiently transmitted through the “yarn having an L value in a range of 70 to 100”. In other words, the light of the linear body is sufficiently transmitted through the “yarn having an L value in a range to 70 to 100” constituting the bag structure portion and sufficiently leaks to the outside (the intensity of the light is further increased). For the configuration of the invention recited in the aforementioned Item. [5], for example, the examples of the configuration include: a configuration in which at least a yarn having an L value in a range of 0 to 50 is used for the weft yarn, and at least a yarn having an L value in a range of 70 to 100 is used for the warp yarn, or a configuration in which a yarn having an L value in a range of 0 to 50 is used as the warp yarn, and a yarn having an L value in a range of 70 to 100 as the weft yarn.

In the invention. as recited in the aforementioned Item [6], since it is configured such that a substantially rectangular seam allowance portion connected to one end portion side of the bag structure portion in the width direction is further provided and a piping material is formed, connecting and attaching to other members is easy. For example, a skin material for a vehicle seat sheet can be provided by sandwiching the seam allowance portion of the piping material between an end portion of the first fabric and an end portion of the second fabric and sewing theme in a state of being overlapped. In this covering material for a vehicle seat sheet, light is transmitted through the beading portion of the piping material and can be visually observed from the outside, resulting in a covering material having a light decorative property.

In the invention as recited in the aforementioned Item [7], it is configured such that a substantially rectangular first seam allowance portion connected to one end portion side of the bag structure portion in a width direction and a substantially rectangular second seam allowance portion connected to the other end portion side of the bag structure portion in the width direction. Therefore, connecting and attaching to other members, etc., is easy. For example, in the invention as recited in the aforementioned Item [7], by overlapping an end portion of the first fabric with the first seam allowance portion of the decorative material and sewing them and by overlapping an end of the second fabric with the second seam allowance portion and sewing them, for example, a skin material for a vehicle seat sheet can be provided. In this skin material for a vehicle seat sheet, light is transmitted through the beading portion and can be visually observed, resulting in a skin material having a light decorative property.

In the invention as recited in the aforementioned. Item [8], the linear body has a diameter of 3.0 mm to 7.0 mm. Since the diameter is 3.0 mm or more, a. sufficient amount of light can be ensured. Since the diameter is 7.0 mm or less, a good texture can be ensured when a human body comes into contact (for example, a good seating feeling), and the improvement in the strength due to the fusion of the thermally fusible yarn can be sufficiently attained.

In the invention as recited in the aforementioned Item [9], it is configured such that the linear body is composed of an optical fiber. Therefore, there is an advantage that the lifetime is significantly longer as compared with that of an EL fiber, for example. For the EL fiber, whether it is an organic EL fiber or an inorganic EL fiber, the material itself emits light and has a service life. On the other hand, the optical fiber is a linear light guide body and can be used for a long time as long as the optical fiber itself is not damaged.

In the inventions as recited in the aforementioned. Items [10] and [11], a vehicle interior material can be provided in which the linear body of the decorative material (the linear light guide body such as an optical fiber or the linear light emitting body such as an EL fiber) is less likely to be damaged, the bag structure portion of the decorative material is less likely to be worn and has excellent abrasion durability, and light decoration property in which light from the linear body (the linear light guide body such as an optical fiber or the linear light emitting body such as an EL fiber) is transmitted through the bag structure portion and leaks to the outside is given.

### BRIEF DESCRIPTION OF THE DRAWINGS

FIG. 1 is a perspective view showing one embodiment of a decorative material according to the present invention.

FIG. 2 is a perspective view showing an appearance of light from the outside (light decoration mode) when light is guided from the end portion of the linear light guide body inside the decorative material of FIG. 1.

FIG. 3 cross-sectional view taken along the line X-X in FIG. 1.

FIG. 4 is an enlarged schematic cross-sectional view showing the cross-sectional view of FIG. 3.

FIG. 5 is a schematic cross-sectional view showing a modified example of the decorative material of FIG. 1.

FIG. 6 perspective view showing another example of the decorative material according to the present invention.

FIG. 7 is a perspective view showing an appearance of light from the outside (light decoration mode) when light is guided from the end portion of the linear light guide body inside the decorative material of FIG. 6.

FIG. 8 is a cross-sectional view taken along the line Y-Y in FIG. 6.

FIG. 9 is an enlarged schematic cross-sectional view showing the cross-sectional view of FIG. 8.

FIG. 10 is a schematic cross-sectional view showing a modified example of the decorative material of FIG. 6.

FIG. 11 is a perspective view showing yet another example of a decorative material according to the present invention.

FIG. 12 is a perspective view showing an appearance of light from the outside (light decoration mode) when light is guided from the end portion of the linear light guide body inside the decorative material of FIG. 11.

FIG. 13 is a cross-sectional view taken along the line Z-Z line in FIG. 11.

FIG. 14 is an enlarged schematic cross-sectional view showing the cross-sectional view of FIG. 13.

FIG. 15 is a schematic cross-sectional view showing a modified example of the decorative material of FIG. 11.

FIG. 16 is a perspective view showing one example of a vehicle seat sheet formed using the decorative material of FIG. 6.

FIG. 17 is a perspective view showing a state in which the seam allowance portion of the decorative material of FIG. 6 is sandwiched between the end portion of the first fabric and the end portion of the second fabric, and the end portion. of the first fabric, the end portion of the second fabric, and the seam allowance portion of the decorative material are sewn together.

FIG. 18 is a cross-sectional view taken along the line S-S in FIG. 16.

FIG. 19 is a perspective view showing one example of a vehicle seat sheet formed using the decorative material of FIG. 11.

FIG. 20 is a cross-sectional view taken along the line T-T in FIG. 19.

FIG. 21 is a perspective view showing still yet another example of the decorative material according to the present invention.

FIG. 22 is a perspective view showing an appearance of light from the outside (light decoration mode) when light is guided from the end portion of the linear light guide body inside the decorative material of FIG. 21.

FIG. 23 is a plan view (woven structure view) showing the bag structure portion in an unfolded state for explaining that the bright portion appears spirally in the beading portion.

FIG. 24 is a plan view showing a first test piece used in the Taber-type scratch test.

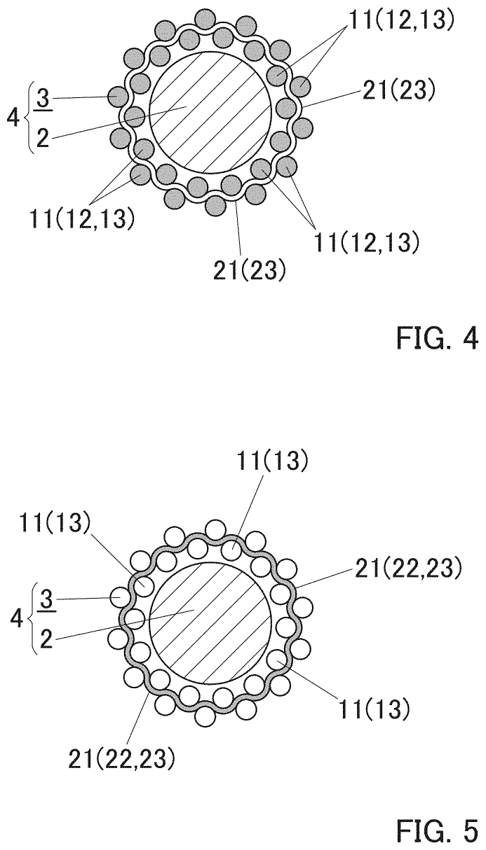

Note that in each of the schematic cross-sectional views of FIGS. 4, 5, 9, 10, 14, and 15, for the purpose of facilitating the understanding of the invention, a warp yarn including a thermally fusible yarn (for example, a warp yarn composed of a twisted yarn in which a thermally fusible yarn and a non-thermally fusible yarn are twisted) and a weft yarn including a thermally fusible yarn (for example, a weft yarn composed of a twisted yarn in which a thermally fusible yarn and a non-thermally fusible yarn are twisted together) are colored gray. That is, in these drawings, a warp yarn that is not colored gray and a weft yarn that is not colored gray are yarns not including a thermally fusible yarn (non-thermally fusible yarn).

### EMBODIMENT FOR CARRYING OUT THE INVENTION

The decorative material 1 according to the present invention is provided with a beading portion 4 including a bag structure portion 3 composed of a tubular fabric and one or a plurality of linear bodies 2 arranged inside the bag structure portion 3. The linear body 2 has a configuration including a linear light guide body or a linear light emitting body.

In the present invention, a configuration in which the warp yarn 11 constituting the bag structure portion 3 includes at least the thermally fusible yarn 12, and/or a configuration in which the weft yarn 21 constituting the bag structure portion 3 includes at least the thermally fusible yarn 22, are adopted.

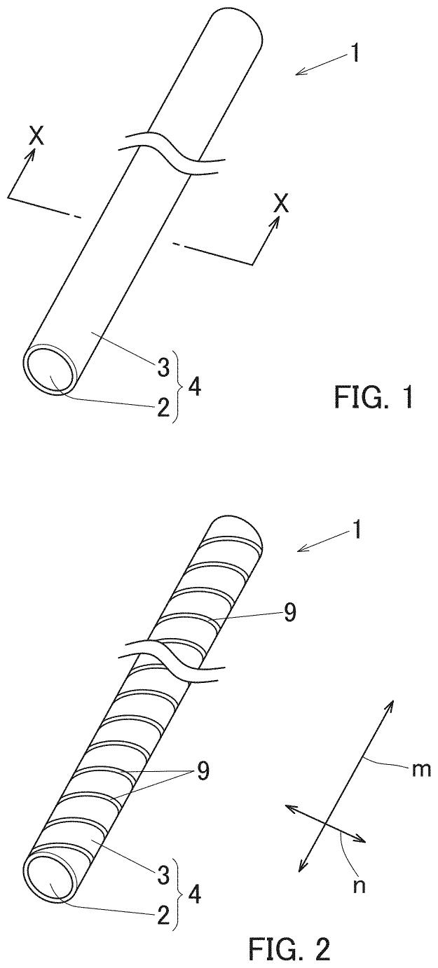

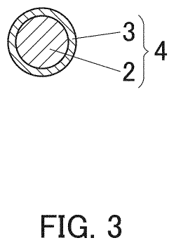

The first embodiment of the decorative material 1 according to the present invention is shown in FIG. 1. In addition, a schematic cross-sectional view of the decorative material 1 in the first embodiment (schematic cross-sectional view taken along the line X-X in FIG. 1) is shown in FIG. 4. In this embodiment, a single piece of a linear body 2 is inserted and arranged inside the bag structure portion 3 formed of a woven structure (see FIGS. 1 to 4). In this embodiment, a linear light guide body is used as a linear body 2. In this embodiment, the axial direction (length direction) of the tubular bag structure portion 3 and the axial direction (length direction) of the linear body 2 are arranged so as to be substantially parallel to each other (see FIG. 1). Further, in this embodiment, a configuration in which the warp yarn 11 constituting the bag structure portion 3 includes at least a thermally fusible yarn 12 is adopted, and specifically, the warp yarn 11 is composed of a twisted yarn in which the thermally fusible yarn 12 and the non-thermally fusible yarn 13 are twisted together (see FIG. 4). Further, the weft yarn 21 constituting the bag structure portion 3 is composed of a non-thermally fusible yarn 23 (see FIG. 4). Since the thermally fusible yarn 12 of the warp yarn 11 is fused to the weft yarn 21, the strength and the surface durability of the bag structure portion 3 can be improved. The decorative material 1 is a non-sewn and uncut product formed by integrally weaving the bag structure portion 3 and the linear body 2 by weaving with a single loom. The loom for integrally weaving such a decorative material 1 is not particularly limited, but for example, a narrow needle-type loom can be exemplified.

A modified example of the decorative material of the aforementioned first embodiment is shown in FIG. 5. In this modified example, the configuration other than the configuration of the bag structure portion 3 is the same as that in the first embodiment. In this modified example, the weft yarn 21 constituting the bag structure portion 3 adopts a configuration including at least a thermally fusible yarn 22, and specifically, the weft yarn 21 is composed of a twisted yarn in which the thermally fusible yarn 22 and the non-thermally fusible yarn 23 are twisted together (see FIG. 5). Further, the warp yarn 11 constituting the bag structure portion 3 is composed of a non-thermally fusible yarn 13 (see FIG. 5). Since the thermally fusible yarn 22 of the weft yarn 21 is fused to the warp yarn 11, the strength and the surface durability of the bag structure portion 3 can be improved.

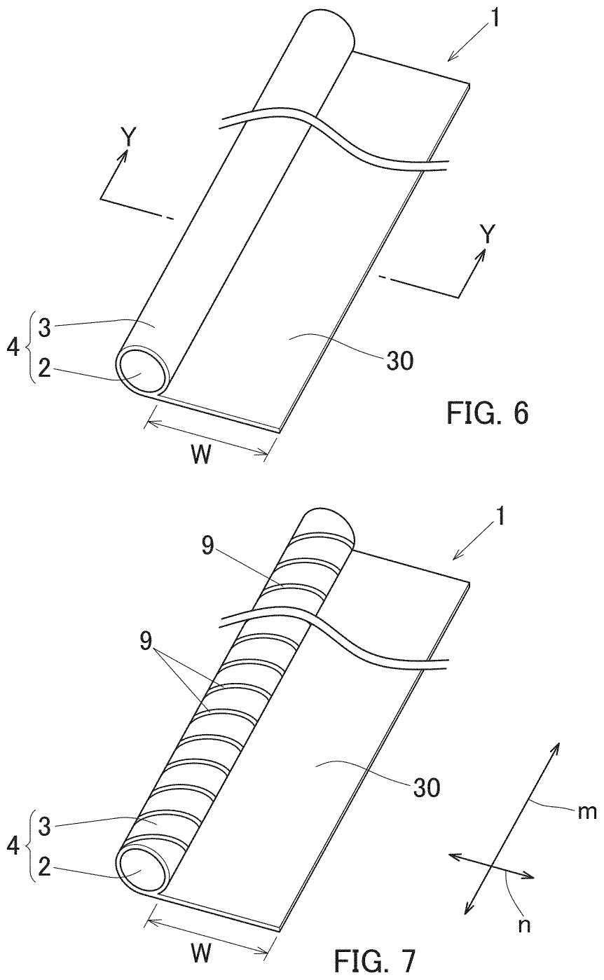

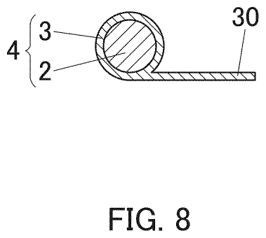

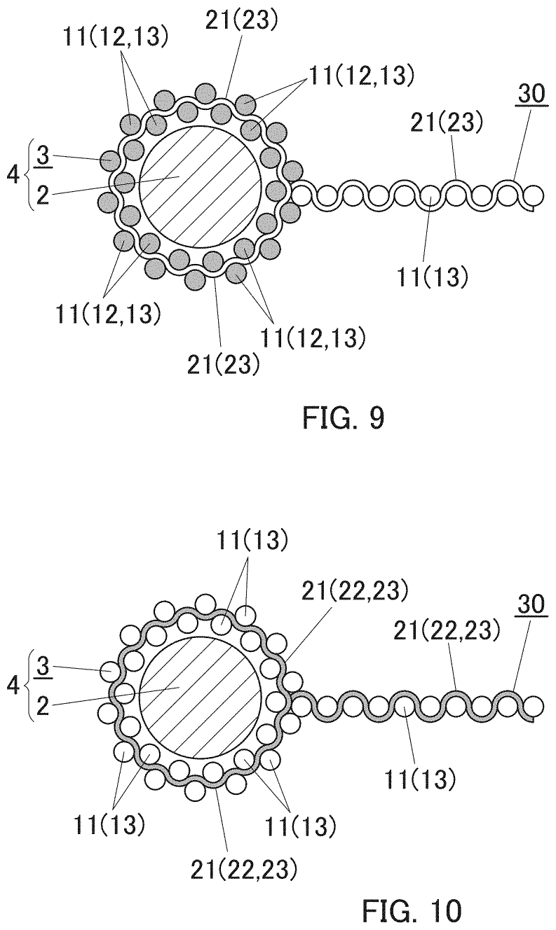

A second embodiment of the decorative material 1 according to the present invention is shown FIG. 6. Further, a schematic cross-sectional view of the decorative material 1 of the second embodiment (schematic cross-sectional view taken along the line Y-Y in FIG. 6) is shown in FIG. 9. In the second embodiment, it is configured such that a beading portion 4 including a bag structure portion 3 composed of a tubular fabric and a linear body 2 arranged inside the bag structure portion 3 is provided and that a seam allowance portion 30 composed of a substantially rectangular fabric connected to one end portion side of the beading portion 4 in the width direction (see FIGS. 6 to 9) is further provided. In the second embodiment, a single piece of a linear body 2 is inserted and arranged inside the bag structure portion 3 and a linear light guide body is used as the linear body 2. In addition, the axial direction (length direction) of the tubular bag structure portion 3 and the axial direction (length direction) of the linear body 2 are arranged so as to be substantially parallel to each other (see FIG. 6). Further, in the second embodiment, the warp yarn 11 constituting the bag structure portion 3 adopts the configuration including at least a thermally fusible yarn 12, and specifically, the warp yarn 11 is composed of a twisted yarn in which the thermally fusible yarn 12 and the non-thermally fusible yarn 13 are twisted together (see FIG. 9). Further, the weft yarn 21 constituting the bag structure portion 3 is composed of a non-thermally fusible yarn 23 (see FIG. 9). Since the thermally fusible yarn 12 of the warp yarn 11 is fused to the weft yarn 21, the strength and the surface durability of the bag structure portion 3 can be improved. The decorative material 1 is a non-sewn and uncut product formed by integrally weaving the bag structure portion 3, the linear body 2, and the seam allowance portion 30 with a single loom. The loom for integrally weaving such a decorative material is not particularly limited, but for example, a narrow needle-type loom can be exemplified.

A modified example of the decorative material 1 of the aforementioned second embodiment is shown in FIG. 10. In this modified example, the configuration other than the configuration of the bag structure portion 3 is the same as that in the second embodiment. In this modified example, the weft yarn 21 constituting the bag structure portion 3 adopts a configuration including at least a thermally fusible yarn 22, and specifically, the weft yarn 21 is composed of a twisted yarn in which the thermally fusible yarn 22 and the non-thermally fusible yarn 23 are twisted together (see FIG. 10). Further, the warp yarn 11 constituting the bag structure portion 3 is composed of a non-thermally fusible yarn 13 (see FIG. 10). Since the thermally fusible yarn 22 of the weft yarn 21 is fused to the warp yarn 11, the strength and the surface durability of the bag structure portion 3 can be improved.

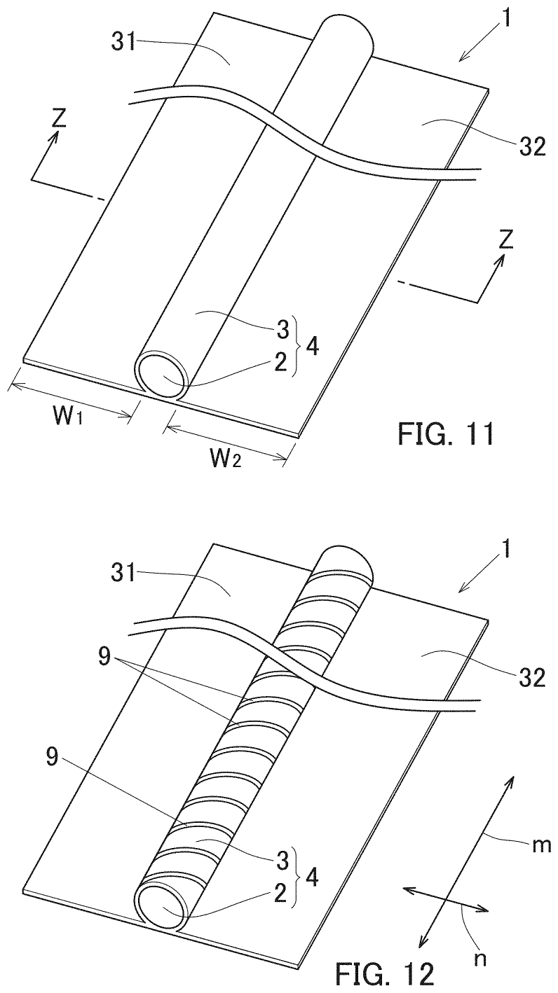

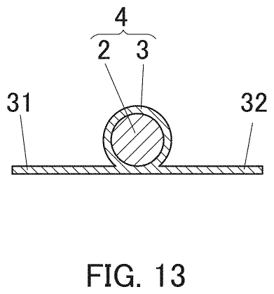

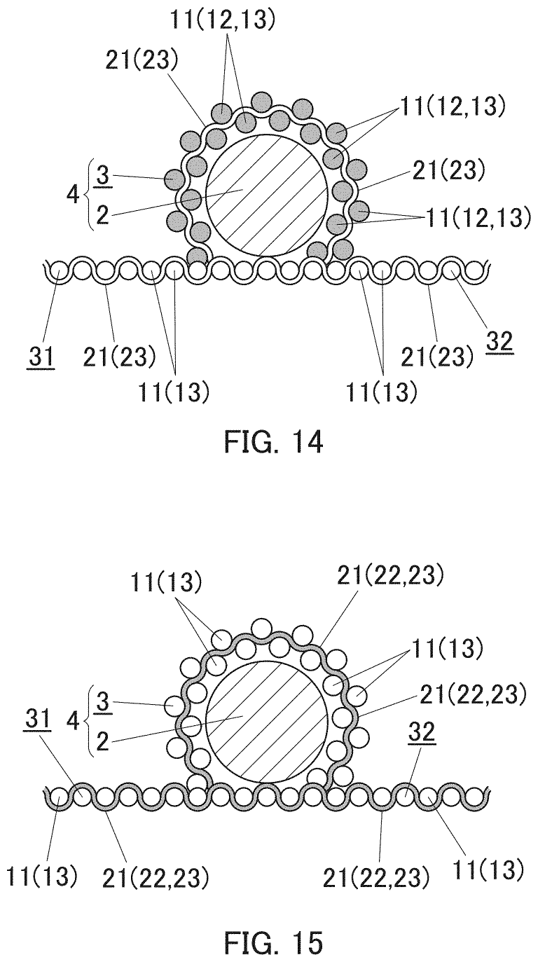

A third embodiment of the decorative material 1 according to the present invention is shown in FIG. 11. Further, the schematic cross-sectional view of the decorative material 1 of the third embodiment (schematic cross-sectional view taken along the line Z-Z in FIG. 11) is shown in FIG. 14. The third embodiment is configured to include a beading portion 4 including a bag structure portion 3 composed of a tubular fabric and a linear body 2 arranged inside the bag structure portion 3, and further include a first seam allowance portion 31 composed of a substantially rectangular fabric connected to one end portion side of the beading portion 4 in the width direction and a second seam allowance portion 32 composed of a substantially rectangular fabric connected to the other end portion side of the beading portion 4 (bag structure portion 3) in the width direction (see FIGS. 11 to 14). In the third embodiment, a single piece of a linear body 2 is inserted and arranged inside the bag structure portion 3, and a linear light guide body is used as the linear body 2. In addition, the axial direction (length direction) of the tubular bag structure portion 3 and the axial direction (length direction) of the linear body 2 are arranged so as to be substantially parallel to each other (see FIG. 11). Further, in the third embodiment, the warp yarn 11 constituting the bag structure portion 3 adopts a configuration including at least a thermally fusible yarn 12, and specifically, the warp yarn 11 is composed of a twisted yarn in which the thermally fusible yarn 12 and the non-thermally fusible yarn 13 are twisted together (see FIG. 14). Further, the weft yarn 21 constituting the bag structure portion 3 is composed of a non-thermally fusible yarn 23 (see FIG. 14). Since the thermally fusible yarn 12 of the warp yarn 11 is fused to the weft yarn 21, the strength and the surface durability of the bag structure portion 3 can be improved. The decorative material 1 is a non-sewn and uncut product formed by integrally weaving the bag structure portion 3, the linear body 2, the first seam allowance portion 31, and the first seam allowance portion 32 with a single loom. The loom for integrally weaving such a decorative material is not particularly limited, but for example, a narrow needle-type loom can be exemplified.

A modified example of the decorative material 1 of the aforementioned third embodiment is shown in FIG. 15. In this modified example, the configuration other than the configuration of the bag structure portion 3 is the same as that in the third embodiment. In this modified example, the weft yarn 21 constituting the bag structure portion 3 adopts a configuration including at least a thermally fusible yarn 22, and specifically, the weft yarn 21 is composed of a twisted yarn in which the thermally fusible yarn 22 and the non-thermally fusible yarn 23 are twisted together (see FIG. 15). Further, the warp yarn 11 constituting the bag structure portion 3 is composed of a non-thermally fusible yarn 13 (see FIG. 15). Since the thermally fusible yarn 22 of the weft yarn 21 is fused to the warp yarn 11, the strength and the surface durability of the bag structure portion 3 can be improved.

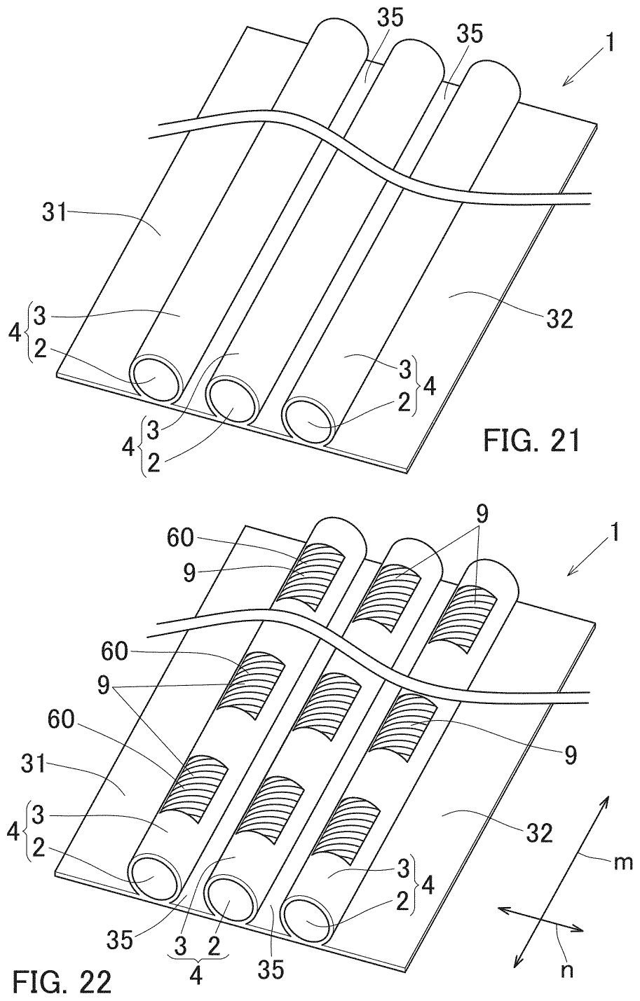

A fourth embodiment of the decorative material 1 according to the present invention is shown in FIG. 21. In the fourth embodiment, it is configured to provide three pieces of (3 pieces) beading portions 4 each including a bag structure portion 3 composed of a tubular fabric, and a linear body 2 arranged inside the bag structure portion 3 and further provide two fabric connecting portions 35 connecting the center beading portion 4 (bag structure portion 3) and the beading portions 4 on both sides of the beading portion 4 (bag structure portion 3) in the width direction, a first seam allowance portion 31 composed of a substantially rectangular fabric connected to an outer end portion of the beading portion 4 (bag structure portion 3) in the width direction on one end portion side of the three beading portion 4 in the width direction among the three beading portions 4, and a second seam allowance portion 32 composed of a substantially rectangular fabric connected to an outer end portion of the beading portion 4 (bag structure portion 3) in the width direction on the other end portion side of the three beading portion 4 in the width direction among the three beading portions 4 (see FIG. 21). In the fourth embodiment, a single piece of a linear body 2 is inserted and arranged inside each bag structure portion 3 and a linear light guide body is used as the linear body 2. Further, the axial direction (length direction) of the tubular bag structure portion 3 and the axial direction (length direction) of the linear body 2 are arranged so as to be substantially parallel to each other (see FIG. 21). In addition, in the fourth embodiment, the warp yarn 11 constituting the bag structure portion 3 adopts a configuration including at least a thermally fusible yarn 12, and specifically, the warp yarn 11 is composed of a twisted yarn in which the thermally fusible yarn 12 and the non-thermally fusible yarn 13 are twisted together. Further, the weft yarn 21 constituting the bag structure portion 3 is composed of a non-thermally fusible yarn 23. Since the thermally fusible yarn 12 of the warp yarn. 11 is fused to the weft yarn 21, the strength and the surface durability of the bag structure portion 3 can be improved. The decorative material 1 is a non-sewn and uncut product formed by integrally weaving the three bag structure portions 3, three linear bodies 2, two connection portions 35, the first seam allowance portion 31, and the second seam allowance portion 32 with a single loom. The loom for integrally weaving such a decorative material is not particularly limited, but for example, a narrow needle-type loom can be exemplified.

In the first to fourth embodiments, the warp yarn 11 constituting the bag structure portion 3 is configured to include at least the thermally fusible yarn 12, but alternatively, the weft yarn 21 constituting the bag structure portion 3 may be configured to include at least the thermally fusible yarn 22. Specifically, it is not especially limited, but, for example, a configuration may be adopted in which the weft yarn 21 constituting the bag structure portion 3 is composed of a twisted yearn in which the thermally fusible yarn 22 and the non-thermally fusible yarn 23 are twisted and the warp yarn 11 constituting the bag structure portion 3 is composed of a non-thermally fusible yarn 13, and the thermally fusible yarn 22 of the weft yarn 21 is fused to the warp yarn 11.

In the decorative material 1 of the present invention as shown in the aforementioned first to fourth embodiments and their modified examples, etc., because of the configuration in which a linear body (the linear light guide body or the linear light emitting body) 2 is inserted and arranged inside the bag structure portion 3 composed of a tubular fabric, a linear light body (the linear light guide body or the Linear light emitting body) 2 is less likely to be damaged even when used in applications in which, for example, a person sits thereon or hands touch. Further, the warp yarn 11 constituting the bag structure portion 3 is configured to include at least a thermally fusible yarn 12, and the thermally fusible yarn 12 is fused to the weft yarn. 21. Furthermore, the weft yarn 21 constituting the bag structure portion 3 is configured to include at least a thermally fusible yarn 22 and the thermally fusible yarn 22 is fused to the warp yarn 11. Therefore, the bag structure portion 3 is less likely to cause losing shape, and the bag structure portion 3 is less likely to wear out and has excellent wear durability. Also, as shown in FIGS. 2, 7, 12, and 22, in the beading portion 1, since light from the linear body (the linear light guide body or the linear light emitting body) 2 leaks through the bag structure portion 3 to the outside, a new and unique light decoration technique can be provided. For example, since the spiral bright portion 9 as shown in FIGS. 2, 7, 12, and 22 can be formed, a new and unique light decoration technique can be provided.

In the present invention, it is preferable to configure such that as one of the yarns between the weft yarn 21 and the warp yarn 11 constituting the bag structure portion 3, at least a yarn having an L value in a range of 0 to 50 is used, and as the other of the yarns, at least a yarn having an L value in a range of 70 to 100 is used. In this case, the light of the linear body (the linear light guide body or the linear light emitting body) 2 is sufficiently transmitted through the “yarn having an L value in a range of 70 to 100” and sufficiently leaks to the outside. In other words, the light of the linear body is sufficiently transmitted through the “yarn having an L value in a range to 70 to 100” and constituting the bag structure portion 3 and sufficiently leaks to the outside (the light strength further increase). The aforementioned “yarn having an L value in a range of 0 to 50” may be a thermally fusible yarn or a non-thermally fusible yarn. In addition, the aforementioned “yarn having an L value in a range of 70 to 100” may be a thermally fusible yarn or a non-thermally fusible yarn.

Among other things, it is preferable to configured such that as one of the weft yarn 21 and the warp yarn 11 constituting the bag structure portion 3, at least a yarn having an L value in a range of 0 to 40 be used, and more preferable to configure such that as the other yarn, at least a yarn having an L value in a range of 80 to 100 be used. Furthermore, it is more preferable to configure such that as one of the weft yarn 21 and the warp yarn 11 constituting the bag structure portion 3, at least a yarn. having an L value in a range of 0 to 35 be used, and as the other yarn, at least a yarn having an L value in a range of 85 to 100 be used. Further, the larger the L value, the greater the light transmittance in the yarn (the greater the amount of light transmitted through the yarn), and the smaller the L value, the smaller the light transmittance of the yarn (the amount of light transmitted through the yarn). The L value of the yarn can be adjusted by, for example, dyeing the yarn, and the L value of the yarn can be set small by dyeing to a dark color and the L value of the yarn can be set large by a light color dyeing, pale color dyeing, or no dyeing, but it is not especially limited to these methods.

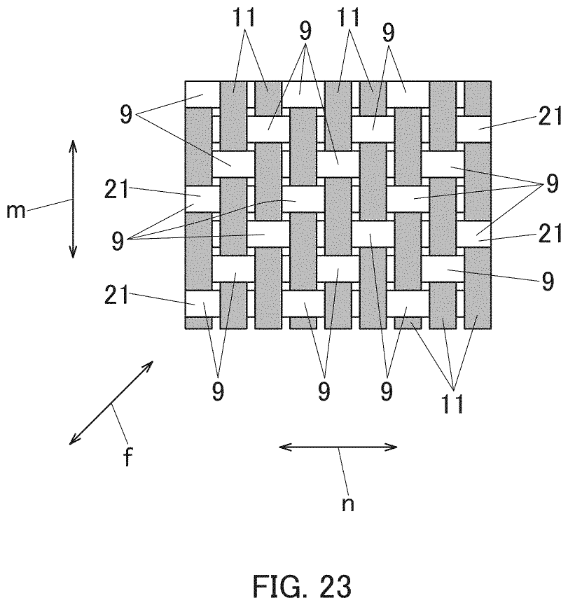

For example, in cases where a yarn having an L value in a range of 0 to 50 is used as the warp yarn 11 constituting the bag structure portion 3, and a yarn having an L value in a range of 70 to 100 is used as the weft yarn 21 constituting the bag structure portion 3, as shown in the woven structure diagram of FIG. 23, since the weft yarn 21 having an L value in a range of 70 to 100 becomes the bright portion 9 in the portion positioned on the warp yarn 11, and these bright portions 9 are connected in the direction of 45 degrees diagonally in FIG. 23 (direction intersecting with the warp direction and the weft direction at 45 degrees), the aforementioned spiral bright portion 9 is observed in the beading portion 4 of the decorative material 1 (bag structure portion 3) (see FIGS. 2, 7, 12, and 22). On the other hand, as shown in the woven structure view of FIG. 23, since the warp yarn 11 having an L value in a range of 0 to 50 hardly transmits or does not transmit light of the linear body 2, the warp yarn 11 having an L value in a range of 0 to 50 hardly illuminates or does not illuminate at all at a portion positioned on the weft yarn 21. In this way, while the warp yarn 11 in the portion positioned on the weft yarn 21 hardly illuminates or does not illuminate at all, the weft yarn 21 in the portion positioned on the warp yarn 11 becomes the bright portion 9. This contrast causes the appearance of the aforementioned spiral bright portion 9 in the beading portion 4 (bag structure portion 3) of the decorative material 1 (FIGS. 2, 7, 12, and 22). Note that in each yarn (warp yarn, weft yarn) in the woven structure view of FIG. 23, when light is guided into the linear body 2 or when the linear body 2 is illuminated, the portion which becomes the bright portion 9 is shown in white (white background) and the portion which is hardly illuminated or is not illuminate at all is shown in dark gray.

Note that, in the fourth embodiment, as shown in FIG. 22, the spiral bright portion 9 is configure to illuminate only in each of the plurality of substantially rectangular fraction portions 60 provided apart from each. other along the length direction of the bag structure portion 3 (bright portions are not observed in regions other than the fraction portions 60 in the bag structure portion 3). Such illumination can be realized by adopting a configuration in which, for example, in the configuration of the beading portion 4 of the third embodiment, a yarn having an L value in a range of 0 to 20 is used as the warp yarn and the weft yarn constituting the region other than the aforementioned fraction portion 60.

In the present invention, the linear body 2 is composed of a linear light guide body or a linear light emitting body. The linear light guide body is not particularly limited, and examples thereof include optical fiber and the like. As the aforementioned optical fiber, it is preferable to use a resin optical fiber. Although the linear light emitting body is not particularly limited, in addition to an EL fiber (also called EL wire, EL tube) such as an inorganic EL fiber, a linear light emitting body composed of an LED (Light Emitting Diode) can be exemplified. The term “linear body” is used to include the meaning of a linear body (tubular body) having a hollow interior. The optical fiber and the EL fiber are often bendable.

The inorganic EL fiber is not particularly limited, but a configuration is known in which, for example, the outer peripheral surface of a linear core electrode is coated with a reflective layer (tubular shape) and the outer peripheral surface of the reflective layer is further provided with a light emitting layer (inorganic EL material) (tubular), and the outer peripheral surface of the light emitting layer is further covered with a transparent electrode layer (tubular shape). The light emitting layer emits light by applying a voltage between the core electrode and the transparent electrode layer to pass a current. By selecting the material of the light emitting layer (inorganic EL material), for example, various light emission colors, such as, e.g., blue light emission color, green light emission color, red light emission color, yellow light emission color, and pink light emission color, can be emitted.

It is preferable that the linear body 2 be a linear body having a diameter of 3.0 mm to 7.0 mm. A sufficient amount of light can be ensured by having a diameter of 3.0 mm or more, and a good texture can be ensured when a human body comes into contact (for example, a good seating feeling) by having a diameter of 7.0 mm or less, and the strength can be sufficiently improved in the bag structure portion 3 by fusing the thermally fusible yarn. It is more preferable that the linear body 2 be a linear body having a diameter of 3.5 mm to 6.5 mm. In addition, when the linear body 2 is a tubular linear body, the term “diameter” refers to the outer diameter of the tubular linear body.

In cases where a linear light guide body (optical fiber or the like) is used as the linear body 2 of the decorative material 1, by connecting a light irradiation device to the end portion of the linear light guide body and guiding the light from the light irradiation device into the linear light guide body (optical fiber or the like), the light from the linear light guide body (optical fiber or the like) 2 leaks to the outside through the bag structure portion 3 in the beading portion 4 of the decorative material 1. Therefore, a new and unique light decoration can be performed. For example, light decoration can be performed by a spiral bright portion 9 as shown in FIGS. 2, 7, 12, and 22.

Further, in the case of using a linear light emitting body (EL fiber, etc.) as the linear body 2 of the decorative material 1, by applying a voltage between the core electrode and the transparent electrode layer of the linear light emitting body to pass a current to illuminate the light emitting layer, the light from the linear light emitting body (EL fiber, etc.) 2 leaks to the outside through the bag structure portion 3 in the beading portion 4 of the decorative material 1, a new and unique light decoration can be performed. For example, light decoration can be performed by the spiral bright portion 9 as shown in FIGS. 2, 7, 12, and 22.

Further, in the aforementioned embodiments, the bright portion 9 is in a spiral shape, but the shape of the bright portion 9 is not particularly limited to such a shape and form. For example, the shape of the bright portion 9 may be, in addition to other linear shapes (straight line, curved lines, broken lines, etc.), a regular pattern, an irregular pattern, or a dot shape, and alternatively, it may be configured such that the entire beading portion 4 is served as the bright portion 9. Further, the linear bright portion 9 may be configured to have a gradation shape in which the brightness of light changes gradually in the length direction of the bright portion 9 (Example 5 explained later).

In the present invention, the thermally fusible yarn 12 and 22 is not particularly limited, but examples thereof include a polyamide yarn and a polyester yarn. It is preferable that the melting point of the thermally fusible yarn be 80° C. to 150° C. Examples of the fusion treatment method of fusing the thermally fusible yarn include, for example, a room heat method and a direct method. The room heat method is a method of performing a heat treatment in a processing machine called a box dryer, and the heat treatment is usually set in a range of 80° C. to 240° C. The direct method is a method of performing a heat treatment in a processing machine called a drum dryer, and the heat treatment is usually set in a range of 80° C. to 150° C.

It is preferable that the thickness of the thermally fusible yarn 12 and 22 be 33 decitex to 330 decitex. When it is 33 decitex or more, joint strength and abrasion resistance can be improved, and when it is 330 decitex or less, appropriate rigidity can be secured without becoming too hard. It is especially preferable that the thickness of the thermally fusible yarn 12 and 22 be 65 decitex to 85 decitex.

In addition, in the case of using the non-thermally fusible yarn 13 and 23, the non-thermally fusible yarn 13 and 23 is not particularly limited, but examples thereof include a polyester multifilament yarn. For the non-thermally fusible yarn 13 and 23, it is preferable to use a yarn having a melting point higher by 30° C. or more than that of the thermally fusible yarns 12 and 22, and it is more preferable to use a yarn higher by 50° C. or more. It is preferable that the thickness of the non-thermally fusible yarn 13 and 23 be 33 decitex to 330 decitex.

In the present invention, the structure of the bag structure portion (tubular portion) 3 is not particularly limited, but examples thereof include bag weaving (a structure in which the warp yarn is dispersed up and down on the front and back and woven into a bag).

The structure of the seam allowance portion 30, the first seam allowance portion 31, and the second seam allowance portion 32 is not particularly limited, but examples thereof include plain weave, twill weave, satin weave, and the like. Among other things, it is preferable that the structure of the seam allowance portion 30, the first seam allowance portion 31, and the second seam allowance portion 32 be twill weave.

Next, usage examples of the decorative material 1 according to the present invention will be described, but they are merely examples and the present invention is not particularly limited to such usage examples.

The decorative material 1 of the first embodiment as shown in FIGS. 1 to 5 may be used, for example, as an edge member for light decoration by being attached to the outer peripheral edge portion of a light cover of a stand light, or may be used as an edge member for light decoration by being attached to the peripheral portion of a bed. Alternatively, the decorative material 1 may be used as, for example, an interior material for an automobile instrument panel (light decoration line member for an automobile instrument panel), an interior material for an automobile door (linear member for light decoration for an automobile door), an interior material for an automobile ceiling material (light decoration for an automobile ceiling material), etc., but not limited to such usage examples.

Further, the decorative material 1 of the second embodiment as shown in FIGS. 6 to 10, the decorative material 1 of the third embodiment as shown in FIGS. 11 to 15, the decorative material 1 of the fourth embodiment as shown in FIGS. 21 and 22, for example, may be used as the following vehicle interior material.

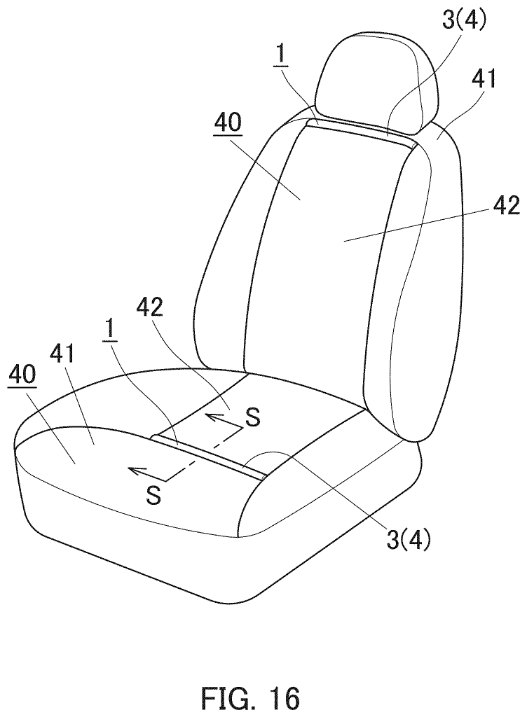

In FIG. 16, a state in which a skin material 40 for a vehicle seat sheet configured using the decorative material 1 of the second embodiment as shown in FIGS. 6 to 10 is mounted on a seat sheet of a vehicle is shown. The partial cross-sectional view in this mounted state is shown in FIG. 18.

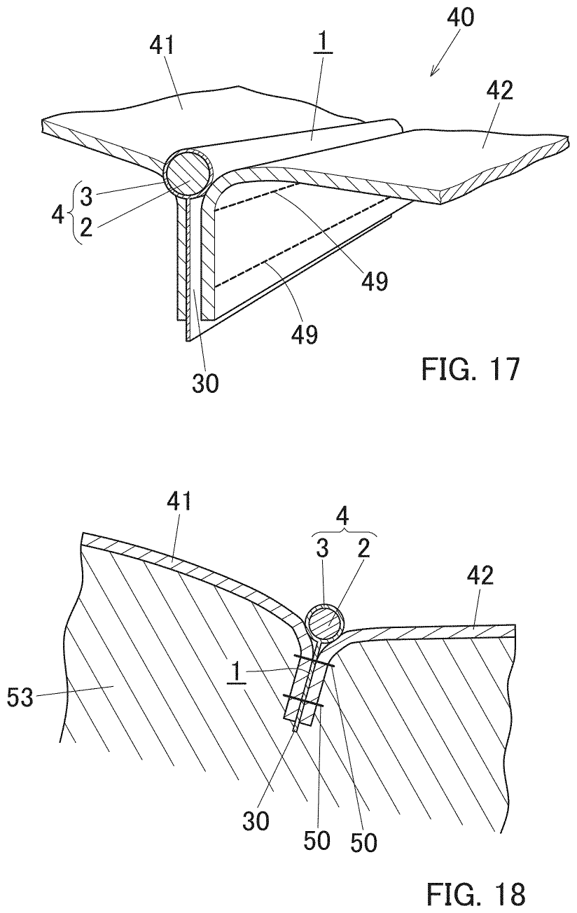

The skin material 40 for a vehicle seat sheet is provided with at least a first fabric 41, a second fabric 42, and the decorative material 1 of the second embodiment. (FIGS. 16 to 18). Further, the seam allowance portion. 30 of the decorative material 1 is sandwiched between an end portion of the first fabric 41 and an end portion of the second fabric 42, and in a state in which the end portion of the first fabric 41, the seam allowance portion 30, and the end portion of the second fabric 42 are overlapped in that order, the end portion of the first fabric 41, the seam allowance portion 30, and the end portion of the second fabric 42 are sewn together (see FIG. 17). In FIG. 17, the numeral “49” denotes a planned sewing portion, and in this embodiment, there are two planned sewing portions (scheduled sewing lines) 49 that are arranged apart from each other in a parallel manner (see FIG. 17).

The skin material 40 for a vehicle seat sheet is obtained by sewing at the two scheduled sewing portions (scheduled sewing line) 49 to form the sewn portion 50 (FIG. 18). The skin material 40 is mounted (arranged) in such manner as to cover the surface of the seat cushion body 53 (see FIG. 18). In this way, a seat sheet for an automobile is configured.

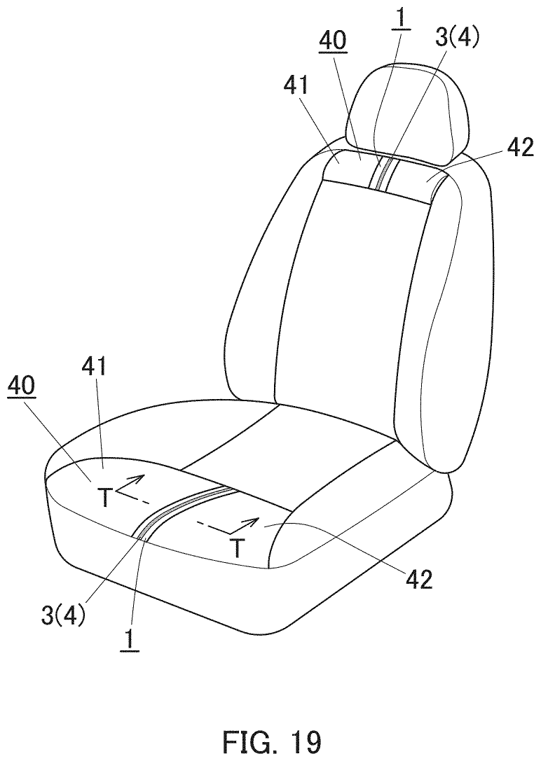

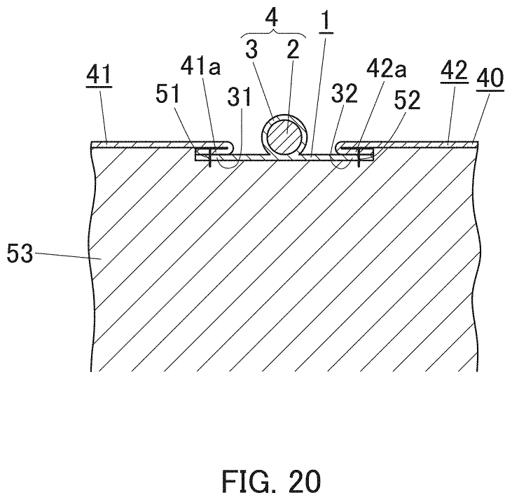

In FIG. 19, a state in which a skin material 40 for a vehicle seat sheet configured using the decorative material 1 of the third embodiment as shown in FIGS. 11 to 15 is mounted on a seat sheet of a vehicle is shown. A partial cross-sectional view in this mounted state is shown in FIG. 20.

The skin material 40 for a vehicle seat sheet includes at least a first fabric 41, a second fabric 42, and the decorative material 1 of the third embodiment (FIGS. 19 to 20).

Accordingly, a first folded portion 41a in which one end portion of the first fabric 41 is folded back on the back side of the first fabric 41 (see FIG. 20) as overlapped with the upper surface of the first seam allowance portion 31 of the decorative material 1, and in such an overlapped state, first folded portion 41a and the first seam allowance portion 31 of the decorative material 1 are sewn together with a first sewing yarn 51 (see FIG. 20), and the first fabric (excluding the first folded portion) 41 is arranged on the sewn first folded portion 41a (see FIG. 20).

Further, a second folded portion 42a in which one end portion of the second fabric 42 is folded back on the back side of the second fabric 42 (see FIG. 20) is overlapped with the upper surface of the second seam allowance portion 32 of the decorative material 1, and in such an overlapped state, the second folded portion 42a and the second seam allowance portion 32 of the decorative material 1 are sewn together with a second sewing yarn 52 (see FIG. 20), and the second fabric (excluding the second folded portion) 42 is arranged on the sewn second folded portion 42a (see FIG. 20).

At the time of use, the skin material 40 for a vehicle seat sheet is mounted (arranged) in such a manner as to cover the surface of the seat cushion body 53 (see FIG. 20). In this way, a seat sheet for an automobile is configured (see FIG. 19).

In the mounted skin material 40 for a vehicle seat sheet (FIGS. 16 to 20), a part (upper surface) of the beading portion 4 of the decorative material 1 is externally observed (see FIGS. 16 to 20). The beading portion 4 of the decorative material 1 is externally observed as a linear shape (line shape) in the skin material 40 as shown in FIGS. 16 and 19.

Here, in cases where a linear light guide body (optical fiber or the like) is used as the linear body 2 of the decorative material 1, by connecting a light irradiation device to the end portion of the linear light guide body 2 and introducing the light from the light irradiation device into the linear light guide body (optical fiber or the like) 2, the light from the linear light guide body (optical fiber or the like) 2 leaks to the outside through the bag structure portion 3 in the beading portion 4 of the decorative material 1 in the skin material 40 for a vehicle seat sheet and the spiral light 9 (see FIGS. 2, 7, and 12) is observed in a line shape as a whole, so a new and unique light decoration can be performed. At night, particularly, the bright portion 9 shows up outstandingly, and therefore a vehicle interior space having sufficiently excellent light decoration can be realized.

Further, in the case of using a linear light emitting body (EL fiber, etc.) as a linear body 2 of the decorative material 1, by applying a voltage between the core electrode and the transparent electrode layer of the linear light emitting body 2 to flow a current to illuminate the light emitting layer, in the beading portion 4 of the decorative material 1 of the skin material 40 for a vehicle seat sheet, the light from the linear light emitting body (EL fiber, etc.) 2 leaks to the outside through the bag structure portion 3. Thus, spiral light 9 (see FIGS. 2, 7, and 12) is observed in a line shape as a whole, so that a new and unique light decoration can be performed. At night, particularly, the bright portion 9 shows up outstandingly, so that a vehicle interior space having excellent light decoration can be realized.

In the aforementioned embodiment (FIGS. 16 to 20), the skin material 40 for a vehicle seat sheet is used in the upper part of the back rest portion and the front part of the seat portion (the portion where the thighs come in contact) of the seat sheet, but the usage location is not especially limited to such portions.

Further, in the aforementioned embodiment (FIGS. 19 and 20), a configuration is adapted in which a first folded portion 41a is formed on the first fabric 41 and the first folded portion 41a is sewn onto the first seam allowance portion 31 of the decorative material 1 (see FIG. 20), but it is not particularly limited to that. For example, a configuration in which the end portion of the first fabric 41 (end portion in an unfolded state) is overlapped with the first seam allowance portion 31 of the decorative material 1 and sewn can be adopted.

Similarly, in the aforementioned embodiment (FIGS. 19 and 20), a configuration is adopted in which a second folded portion 42a is formed on the second fabric 42 and the second folded portion 42a is sewn onto the second seam allowance portion 32 of the decorative material 1 (see FIG. 20), but it is not particularly limited to that. For example, a configuration may be adopted in which the end portion of the second fabric 42 (end portion in an unfolded state) is overlapped with the second seam allowance portion 32 of the decorative material 1 and sewn.

Further, in the aforementioned embodiment (FIGS. 19 and 20), the first fabric 41 is a fabric constituting the left side material of the skin material 40, and the second fabric 42 is a fabric constituting the right side material of the skin material 40, but this merely one example, and it is not particularly limited to such a configuration and form.

The first fabric 41 and the second fabric 42 are not particularly limited, but examples thereof include a dobby fabric (polyester fiber dobby fabric, etc.), a jacquard fabric (polyester fiber jacquard fabric, etc.), a tricot (polyester fiber tricot, etc.), a circular knitted fabric (polyester fiber circular knitted fabric, etc.), and a Russel fabric (polyester fiber raschel fabric, etc.).

The sewing yarns 51 and 52 used for sewing are not particularly limited, but examples thereof include a polyester spinning yarn, etc. The thickness of the sewing yarn 51 and 52 is preferably No. 4 to No. 12.

### EXAMPLES

Next, specific examples of the present invention will be described, but the present invention is not particularly limited to these examples.

### Example 1

After weaving under the following design and conditions, heating was performed at 130° C. for 3 minutes to obtain a decorative material 1 as shown in FIG. 1 in which the beading portion had the schematic cross-sectional configuration shown in FIG. 5.

Loom.: narrow needle loom

warp density: 115 pieces/2.54 cm

weft density: 122 pieces/2.54 cm

warp yarn: (bag structure portion; tubular portion): 167 decitex polyester multifilament yarn (dark blue dyeing yarn; non-thermally fusible yarn)

weft yarn (bag structure portion; tubular portion): 192 pieces of twisted composite yarns (twisted yarns) formed by winding a 78 decitex polyamide yarn (thermally fusible yarns melting point 120° C.) (undyed white yarn) around a 110 decitex polyester multifilament yarn (unstained white yarn; non-thermally fusible yarn) (twisted 200 times/m)

inserted yarn: one piece of an acrylic resin optical fiber having a diameter of 3.5 mm

structure of bag structure portion (tubular portion): satin structure

### Example 2

After weaving under the following design and conditions, heating was performed at 130° C. for 3 minutes to obtain a decorative material 1 as shown in FIG. 6 in which the beading portion had the schematic cross-sectional configuration shown in FIG. 10.

Loom: narrow needle loom

warp density: 170 pieces/2.54 cm

weft density: 122 pieces/2.51 cm

warp yarn: (bag structure portion; tubular portion): 167 decitex polyester multifilament yarn (dark blue dyeing yarn; non-thermally fusible yarn)

weft yarn (bag structure portion; tubular portion): 192 pieces of twisted yarns (twisted yarn) formed by winding a 78 decitex polyamide yarn (thermally fusible yarn; melting point 120° C.) (undyed white yarn) around a 110 decitex polyester multifilament yarn (unstained white yarn; non-thermally fusible yarn) (twisted 200 times/m)

warp yarn (seam allowance portion): 110 pieces of 167 decitex polyester multifilament yarns (twisted yarns; twisted 300 times/m)

weft yarn (seam allowance portion): 192 pieces of twisted yarns (twisted yarns) formed by winding 110 decitex polyester multifilament yarn (unstained white yarn; non-thermally fusible yarn) (twisted 200 times/m)

inserted yarn: one piece of an acrylic resin optical fiber having a diameter of 3.5 mm

structure of seam allowance portion: satin weave

structure of bag structure portion (tubular portion): satin structure

width W of seam allowance portion: 8 mm

### Example 3

After weaving under the following design and conditions, heating was performed at 130° C. for 3 minutes to obtain a decorative material 1 as shown in FIG. 11 in which the beading portion had the schematic cross-sectional configuration shown in FIG. 15.

Loom: narrow needle loom.

warp density: 208 pieces/2.54 cm

weft density: 125 pieces/2.54 cm

warp yarn: (hag structure portion; tubular portion): 167 decitex polyester multifilament yarn (dark blue dyeing yarn.; non-thermally fusible yarn)

weft yarn (bag structure portion; tubular portion): 192 pieces of twisted composite yarns (twisted yarns) formed by winding a 78 decitex polyamide yarn (thermally fusible yarn; melting point 120° C.) (undyed white yarn) around a 110 decitex polyester multifilament yarn (unstained white yarn; non-thermally fusible yarn) (twisted. 200 times/m)

warp yarn (first, second seam allowance portion): 110 pieces of 167 decitex polyester multifilament yarns (twisted yarn; twisted 300 times/m)

weft yarn (first, second seam allowance portion): 192 pieces of twisted yarns (twisted yarn) formed by winding a 110 decitex polyester multifilament yarn (unstained white yarn; non-thermally fusible yarn) (twisted 200 times/m)

inserted yarn: one piece of an acrylic resin optical fiber having a diameter of 3.5 mm.

structure of first, second seam allowance portion: satin weave

structure of bag structure portion (tubular portion): satin structure

width W₁ of the first seam allowance portion: 8 mm

width W₂ of the second seam allowance portion: 8 mm

### Example 4

The decorative material 1 as shown in FIG. 1 in which. the beading portion had the schematic cross-sectional configuration as shown in FIG. 5 was obtained in the same manner as in Example 1 except that one piece of an EL fiber having a diameter of 6.0 mm was used instead of one piece of a resin optical fiber having a diameter of 6.0 mm as the inserted yarn.

As the EL fiber, an EL fiber having a configuration (having a whole diameter of 6.0 mm) was used in which an outer peripheral surface of a linear core electrode was covered with a tubular reflective layer, the outer peripheral surface of the tubular reflective layer was further covered with a tubular light emitting layer (inorganic EL material), and the outer peripheral surface of the light emitting layer was further covered with a tubular transparent electrode layer. In the EL fiber, the light emitting layer emitted red light by applying a voltage between the core electrode and the transparent electrode layer to pass a current.

### Example 5

After weaving under the following design and conditions, heating was performed at 130° C. for 3 minutes to obtain a decorative material 1 as shown in FIG. 11 in which the beading portion had the schematic cross-sectional configuration shown in FIG. 15. However, in Example 5, since a thermally fusible yarn 12 was used as the warp yarn 11 constituting the bag structure portion, it had a configuration in which a thermally fusible yarn 12 was used instead of the non-thermally fusible yarn 13 as shown in the drawing as the warp yarn 11 in FIG. 15 (the other configurations were the same as the schematic cross-sectional structure as shown in FIG. 15).

Loom: narrow needle loom

warp density: 210 pieces/2.54 cm

weft density: 125 pieces/2.54 cm

warp yarn (bag structure portion tubular portion):

two pieces of 245 decitex twisted yarns (twisted yarns) formed by winding a 78 decitex polyamide yarn (thermally fusible yarn; melting point 120° C.) (undyed white yarn) around a 167 decitex polyester multifilament yarn (dark blue dyed yarn; non-thermally fusible yarn) (twisted 200 times/m)

two pieces of 245 decitex twisted yarns (twisted yarns) formed by winding a 78 decitex polyamide yarn (thermally fusible yarn; melting point 120° C.) (undyed white yarn) around a 167 decitex polyester multifilament yarn (medium blue dyed yarn; non-thermally fusible yarn) (twisted 200 times/m)

two pieces of 245 decitex twisted yarns (twisted yarns) formed by winding a 78 decitex polyamide yarn (thermally fusible yarn; melting point 120° C.) (undyed white yarn) around a 167 decitex polyester multifilament yarn (light blue dyed yarn; non-thermally fusible yarn) (twisted 200 times/m)

three pieces of 245 decitex twisted yarns (twisted yarns) formed by winding a 78 decitex polyamide yarn (thermally fusible yarn; melting point 120° C.) (undyed white yarn) around a 167 decitex polyester multifilament yarn (unstained white yarn; non-thermally fusible yarn) (twisted 200 times/m)

two pieces of 245 decitex twisted yarns (twisted yarns) formed by winding a 78 decitex polyamide yarn (thermally fusible yarn; melting point 120° C.) (undyed white yarn) around a 167 decitex polyester multifilament yarn (light blue dyed yarn; non-thermally fusible yarn) (twisted 200 times/m)

two pieces of 245 decitex twisted yarns (twisted yarns) formed by winding a 78 decitex polyamide yarn (thermally fusible yarn; melting point 120° C.) (undyed white yarn) around a 167 decitex polyester multifilament yarn (medium blue dyed yarn; non-thermally fusible yarn) (twisted 200 times/m)

two pieces of 245 decitex twisted yarns (twisted yarns) formed by winding a 78 decitex polyamide yarn (thermally fusible yarn; melting point 120° C.) (undyed white yarn) around a 167 decitex polyester multifilament yarn (dark blue dyed yarn; non-thermally fusible yarn) (twisted 200 times/m)

were used as a warp yarn in an arrangement in that order, and a weft yarn (bag structure portion; tubular portion) was woven so that the three pieces of the aforementioned unstained yarns were on top of the bag structure portion (top portion of the bag structure portion in FIG. 11):

192 pieces of twisted composite yarns (twisted yarns) formed by winding a 78 decitex polyamide yarn (thermally fusible yarn; melting point 120° C.) (undyed white yarn) around a 110 decitex polyester multifilament yarn (unstained white yarn; non-thermally fusible yarn) (twisted 200 times/m)

warp yarn (first, second seam allowance portion): 110 pieces of 167 decitex polyester multifilament. yarns (twisted yarn; twisted. 300 times/m)

weft yarn (first, second seam allowance portion): 192 pieces of twisted yarns (twisted yarns) formed by winding a 110 decitex polyester multifilament yarn (unstained white yarn; non-thermally fusible yarn) (twisted 200 times/m)

inserted yarn: one piece of an acrylic resin optical fiber having a diameter of 3.5 mm

structure of first, second seam allowance portion: satin weave

structure of bag structure portion (tubular portion): satin structure

width W₁ of first seam allowance portion: 8 mm

width W₂ of second seam allowance portion: 8 mm

### Comparative Example 1

A decorative material was obtained in the same manner as in Example 1 except that as the weft yarn constituting the bag structure portion (tubular portion), 125 pieces of yarns of a 110 decitex polyester multifilament yarn (undyed white yarn) (twisted yarn; twisted 200 times/m) (thermally fusible yarn was not used) were used.

### Measurement Method of L Value of Yarn

The L value of the warp yarn (dark blue dyed yarn) constituting the bag structure portion used in Examples 1 to 4 and Comparative Example 1 was 38.47. Further, the L value of the dark blue dyed yarn used as the warp yarn constituting the bag structure portion in Example 5 was 35.2, the L value of the medium blue dyed yarn was 51.2, the L value of the light blue dyed yarn was 66.8, and the L value of the undyed yarn was 95.12.

Furthermore, the L value of the weft yarn constituting the bag structure portion (twisted yarn of an undyed white yarn composed of a non-thermally fusible yarn and an undyed white yarn composed of a thermally fusible yarn) used in Examples 1 to 5 and Comparative Example 1 was 95.7.

These L values are L values measured according to JIS Z8722 (2009) using a spectrophotometer “CM3600A” manufactured by Konica Minolta, Inc. In addition, the larger the L value, the higher the light transmittance, and the L value of 100 means that light theoretically transmits the yarn by 100%. On the other hand, the smaller the L value, the smaller the light transmittance, and the L value of 0 means that light theoretically does not transmit through the yarn and shields light completely.

With respect to each decorative material obtained as described above, evaluation was conducted based on the following evaluation method. The results are shown in Table 1.

### Light Decoration Property Evaluation

The light decoration property of the beading portion of the decorative material was evaluated according to the following evaluation criteria by connecting a light irradiation device to an end portion of the optical fiber of each decorative material in Examples 1 to 3, 5, and Comparative Example 1 and introducing light from the light irradiation device into the optical fiber. Further, an EL energization device was connected to an end portion of an EL fiber of the decorative material of Example 4, and the light decoration property of the beading portion by the illumination of the EL fiber due to the energization (applying a voltage between the core electrode and the transparent electrode layer) was evaluated according to the following evaluation criteria.

### Evaluation Criteria

“◯”: light from the optical fiber or the EL fiber (bright portion) could be observed externally through the bag structure portion in the beading portion, so light decoration was provided
“X”: light from the optical fiber or the EL fiber (bright portion) could not be observed externally through the bag structure portion in the beading portion, so light decoration was not provided.

In the decorative material of Examples 1 and 4, the bright portion 9 was observed externally in a spiral manner (spiral shape) as shown in FIG. 2. Also, in the decorative material of Example 2, the bright portion 9 was observed externally in a spiral manner as shown in FIG. 2 in the beading portion 4 as shown in FIG. 7. Also, in the decorative material of Example 3, the bright portion 9 was observed externally in a spiral manner in the beading portion 4 as shown in FIG. 12.

Further, in the decorative material in Example 5, in the beading portion 4 as shown in FIG. 12, the linear (spiral) bright portion 9 was observed in a gradation manner in which the brightness of the light changed gradually (four step) in the lengthwise direction of the bright portion 9. In FIG. 12, the light gradation was observed in which the light from the top of the beading portion 4 was the brightest among the four steps, and the brightness of the light decreased gradually as It approached the first, second seam allowance portion (bottom of the beading portion 4).

### Surface Durability Evaluation Method of Decorative Material

### Taber Scratch Test

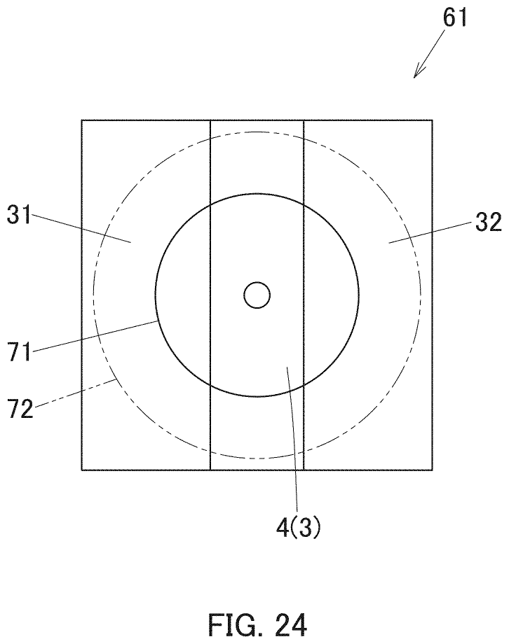

Each of the obtained decorative materials was cut to obtain a first test piece 61 having the shape as shown in FIG. 24. Further, it was cut at the circular cutting line (two-dot chain line) 72 and was made circular. Next, a needle was attached. to the Taber scratch test device, and the tip of the needle (needle tip) was put in contact with the surface of the first test piece 61 and in a state in which a load of 200 g was applied to the needle, two rotations were made at a rotation speed of 1 rpm. The circular solid line 71 in FIG. 24 is the contact trajectory of the needle tip. After the test, the surface property of the first test piece was visually observed and evaluated based on the following evaluation criteria. Grades 3, 4, and 5 were considered to be acceptable. Note that FIG. 24 shows the decorative material of Examples 3 and 5, but the same Taber type scratch test was performed in the same manner for the decorative materials of the other Examples and Comparative Examples.

### Evaluation Criteria

Grade 5: no damage was observed

Grade 4: damage from scratch was observed, but there was no yarn sticking out

Grade 3: there was a yarn sticking out, but it was not noticeable. Fiber was cut, but it was not noticeable.

Grade 2: there was a yarn sticking out, and it was noticeable. Fiber was cut and it was noticeable.

Grade 1: yarn significantly stuck out and it was noticeable.

Fiber was cut and broken.

### Wear Resistance Evaluation Method of Decorative Material

The wear resistance test was performed in accordance with JIS L1096-2010 8.19.3 C method (Taber method) under the conditions of wear wheel CS-10, load 500 g, 1000 rotations, then the surface of the decorative material was visually observed and evaluated under the following evaluation criteria. Grades 3, 4, and 5 were considered to be acceptable.

### Evaluation Criteria

Grade 5: no lint

Grade 4: slight lint was observed, but there was no practical problem

Grade 3: slight lint was observed, but there was no practical problem

Grade 2: there was a lot of lint and the yarn had thinned

Grade 1: the yarn was cut

TABLE 1

| | | | | | | Comp. |
|---|---|---|---|---|---|---|
| | Ex. 1 | Ex. 2 | Ex. 3 | Ex. 4 | Ex. 5 | Ex. 1 |
| Corresponding | FIG. 1, | FIG. 6, | FIG. 11, | FIG. 1, | FIG. 11, | — |
| FIGS. | FIG. 2 | FIG. 7 | FIG. 12 | FIG. 2 | FIG. 12 | |
| Linear body | Optical | Optical | Optical | EL | Optical | Optical |
| | fiber | fiber | fiber | fiber | fiber | fiber |
| Light | ○ | ○ | ○ | ○ | ○ | ○ |
| decoration | | | | | | |
| evaluation | | | | | | |
| Taber scratch | 3 | 3 | 3 to 4 | 3 to 4 | 3 to 4 | 2 |
| test | | | | | | |
| Abrasion | | | | | | |
| resistance | 3 to 4 | 3 to 4 | 3 to 4 | 3 to 4 | 3 to 4 | 2 |
| evaluation | | | | | | |

As it is apparent from Table 1, the decorative materials of Examples 1 to 5 according to the present invention had light decoration properties, durability against scratches, etc., excellent surface durability, and abrasion resistance.

On the other hand, in Comparative Example 1, although it had decoration properties, the Taber scratch test was evaluated as Grade 2, and the surface durability was inferior.

### INDUSTRIAL APPLICABILITY

The decorative material according to the present invention is preferably used as a decorative material for a vehicle interior material such as an interior material for an automobile instrument panel, an interior material for an automobile door, an interior material for an automobile ceiling material, etc., and a decorative material suitably used for indoor use for an indoor interior material, a carpet, a stand light, bedding, and the like, but not particularly limited to these usages.

In the carpet application, the decorative material of the present invention can be used for, for example, an overlook portion of a carpet. In addition, in a stand light application, the decorative material of the present invention can be used for, for example, an edge member of a light cover.

### DESCRIPTION OF REFERENCE SYMBOLS

1: decorative material

2: linear body

3: bag structure portion(tubular portion)

4: beading portion

9: bright portion

11: warp yarn

12: thermally fusible yarn(warp yarn)

13: non-thermally fusible yarn(warp yarn)

21: weft yarn

22: thermally fusible yarn(weft yarn)

23: non-thermally fusible yarn(weft yarn)

30: seam allowance portion

31: first seam allowance portion

32: second seam allowance portion

40: skin material for vehicle seat sheets

41: first fabric

42: second fabric

f: longitudinal direction of the bright portion

m: direction of the warp yarn (warp direction)

n: direction of the weft yarn (weft direction)

1. A decorative material comprising:
a beading portion including a bag structure portion composed of a tubular fabric and one or a plurality of linear bodies arranged inside the bag structure portion,
wherein the linear body includes one of a linear fight guide body and a linear light emitting body, and
wherein a warp yarn constituting the bag structure portion is configured to include at least thermally fusible yarn.

2. The decorative material as recited in claim 1,
wherein the warp yarn is composed of a twisted yarn in which the thermally fusible yarn and a non-thermally fusible yarn are twisted together.

3. A decorative material comprising:
a beading portion including a bag structure portion composed of a tubular fabric and one or a plurality of linear bodies arranged. Inside the bag structure portion,
wherein the linear body includes one of a linear light guide body and a linear light emitting body, and
wherein a weft yarn constituting the bag structure portion is configured to include at least a thermally fusible yarn.

4. The decorative material as recited in claim 3,
wherein the weft yarn is composed of a twisted yarn in which a thermally fusible yarn and a non-thermally fusible yarn are twisted together.

5. The decorative material as recited in claim 1,
wherein one of the warp yarn and the weft yarn constituting the bag structure portion includes a yarn having an L value in a range of 0 to 50, and the other of the warp yarn and the weft yarn includes a yarn having an L value in a range of 70 to 100.

6. The decorative material as recited in claim 1, further comprising:
a substantially rectangular seam allowance portion connected to one end portion side of the bag structure portion in a width direction.

7. The decorative material as recited in claim 1, further comprising:
a substantially rectangular first seam allowance portion connected to one end portion side of the bag structure portion in the width direction; and
a substantially rectangular second seam allowance portion connected to the other end portion side of the beading portion in the width direction.

8. The decorative material as recited in claim 1,
wherein the linear body has a diameter of 3.0 mm to 7.0 mm.

9. The decorative material as recited claim 1,
wherein the linear body is composed of an optical fiber.

10. A vehicle interior material comprising:
a first fabric;
a second fabric; and
the decorative material as recited in claim 6,
wherein the seam allowance portion of the decorative material is sandwiched between an end portion of the first fabric and an end portion of the second fabric, and the seam allowance portion, the end portion of the first fabric, and the end portion of the second fabric are sewed together in a state of being overlapped.

11. A vehicle interior material comprising:
a first fabric;
a second fabric; and
the decorative material as recited in claim 7,
wherein an end portion of the first fabric is overlapped with the first seam allowance portion of the decorative material, and the end portion of the first fabric and the first seam allowance portion are sewed together, and
wherein an end portion of the second fabric is overlapped with the second seam allowance portion of the decorative material, and the end portion of the second fabric and the second seam allowance portion are sewed together.
